(19) United States
(12) Patent Application Publication
(10) Pub. No.: US 2014/0310139 A1
(43) Pub. Date: Oct. 16, 2014

(54) TIME TRACKING SYSTEM AND METHOD

(71) Applicants: Erik Cornet, Austin, TX (US); Chris Gibson, Austin, TX (US)

(72) Inventors: Erik Cornet, Austin, TX (US); Chris Gibson, Austin, TX (US)

(73) Assignee: Pelorus Technology, LLC, Austin, TX (US)

(21) Appl. No.: 13/954,981

(22) Filed: Jul. 31, 2013

Related U.S. Application Data
(63) Continuation-in-part of application No. 13/987,322, filed on Dec. 31, 2012.
(60) Provisional application No. 61/677,396, filed on Jul. 30, 2012.

(51) Int. Cl. G06Q 40/00

(52) U.S. Cl. CPC G06Q 40/125
USPC 705/32

(57) ABSTRACT

A time keeping system that operates within a personal information management application and includes a time capture component, a time preparation component and a time posting component. The time capture component includes at least one capture process that is configured to identify and record parameters associated with a billable event, such as creating an email, placing a phone call, receiving a phone call or some other similar event. Selected values are then entered for each billable event by the processes of the time preparation component. The time preparation component also enables a user to combine the parameters and values of a billable event into a new billable event. The time posting component enables the user to post the parameters and values associated with selected billable events to an accounting system.

### RELATED APPLICATIONS

The present application claims the benefit of U.S. Provisional Patent Application Ser. No. 61/677,396, filed Jul. 30, 2012 and entitled “Time Tracking System and Method,” the disclosure of which is herein incorporated by reference.

### FIELD OF INVENTION

The present invention relates generally to manual and automatic computer methods and systems for tracking and capturing time spent on various tasks and events, for preparing such captured tasks and events for billing and for posting the prepared tasks and events to an accounting system.

### BACKGROUND OF THE INVENTION

Various professionals, such as legal professionals, must account for and track the time they spend on certain activities for billing purposes. The clients of these types of professionals require the professional to accurately provide the client with incremental details of the time spent on various tasks, activities and projects before that client will pay for the professional's services. In the past, professionals have kept track of their time on such tasks, activities and projects for clients using various methods, such as handwritten time sheets, computer spreadsheets and other various means of manual entries. For example, some professionals use a computer or a printed calendar, and fill in the tasks and projects they perform throughout the day on such a calendar.

These types of manual methods of capturing and tracking time are often inefficient, inaccurate and cumbersome. Importantly, relying on such manual methods can result in a failure to identify each activity performed, or a failure to accurately account for the time spent on each activity. Often, professionals are extremely busy, have many different clients and accounts and have difficulty keeping track of all of the time they spend on the various tasks they perform throughout the day. Accordingly, such professionals lose time by failing to record certain tasks, and in effect are unable to bill the client for these untracked tasks.

Although some automated processes exist, the previous automated processes and systems do not sufficiently capture all of the various tasks professionals perform during the day. Additionally, previous automated processes are not intuitive and easy for professionals to use and do not allow a professional to control the preparation and posting of events to an automated billing accounting system.

Accordingly, an automated system is needed to allow professionals to capture every billable task performed during a day, and in effect eliminate “white space” (the time periods on their calendar that lack recorded activities). Additionally, an automated system is needed to capture time spent reading, composing and replying to emails, to capture time spent editing and composing documents on a computer and to capture time spent on making and receiving phone calls. Finally, an automated system is needed to allow a professional to easily prepare captured tasks and events for billing and allow the professional, or the professional's delegate, to easily post such prepared billing events to an automated billing accounting system.

### SUMMARY OF THE INVENTION

In a preferred embodiment, the present invention includes a computer system configured to capture parameters and values related to billable events and to post those parameters and values to an accounting program. The system includes at least one capture component configured to automatically determine the parameters of a billable event. The system also includes a calendar object configured to display the billable events and parameters determined by the capture component. The system further includes a time preparation component configured to determine the values associated with the billable event displayed by the calendar object and a posting component configured to retrieve the parameters and values of selected billable events displayed in the calendar object and post those parameters and values to the accounting program. The time preparation component of the system can combine the parameters and values of each of the billable events in a selected plurality of billable events and create a new billable event.

### BRIEF DESCRIPTION OF DRAWINGS

FIG. 1 is a block diagram illustrating the various components of the time keeping method and system.

FIG. 2 is a flow chart diagram illustrating steps associated with the manual event time capturing component.

FIG. 3 is a flow chart diagram illustrating steps associated with the automatic time capturing component related to editing and composing computer documents.

FIG. 4 is a flow chart diagram illustrating steps associated with the automatic time capturing component related to reading an email.

FIG. 5 is a flow chart diagram illustrating steps associated with the automatic time capturing component related to composing an email or replying to an email.

FIG. 6 is a flow chart diagram illustrating steps associated with the automatic time capturing component related to initiating a phone call.

FIG. 7 is a flow chart diagram illustrating steps associated with the automatic time capturing component related to receiving a phone call.

FIG. 8 is a flow chart diagram illustrating steps associated with the coding process of the time preparation component.

FIG. 9 is an exemplary illustration of the Caelus control tab associated with the coding process of the time preparation component.

FIG. 10 is a flow chart diagram illustrating steps associated with the soap bubble process of the time preparation component.

FIG. 10A is an exemplary illustration of a time management application before selection of certain events.

FIG. 10B is an exemplary illustration of a time management application wherein certain events selected by the user are highlighted.

FIG. 10C is an exemplary illustration of a time management application wherein certain events have been combined by the invention.

FIG. 11 is a flow chart diagram illustrating steps associated with the mark ready process of the time preparation component.

FIG. 12 is a flow chart diagram illustrating steps associated with the time posting component.

### WRITTEN DESCRIPTION

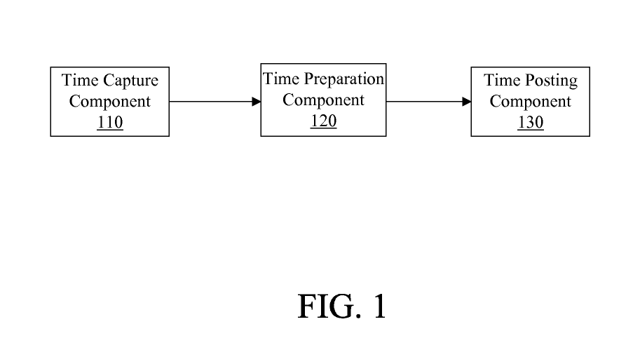

FIG. 1 is a block diagram illustrating the components of a time keeping system 100 that can be implemented in a time management application, personal information management application, or other similar application. The time keeping system 100 is utilized to capture event information, and prepare that information for subsequent posting and processing within an accounting system. In a preferred embodiment, the accounting system is Microsoft Dynamics AX, but it will be understood that the invention can be used with other accounting systems commonly employed by lawyers and other professionals.

The time keeping system 100 may be running on a typical desktop or laptop computer commonly employed in professional practices. Alternatively, the time keeping system 100 may be running an a commonly available mobile phone. Indeed, the time keeping system 100 may run separately on a mobile phone and a desktop/laptop computer. The preferred embodiment of the time keeping system 100 utilizes a time management application such as the Outlook application by the Microsoft Corporation; however, alternative embodiments may utilize other applications.

As depicted in FIG. 1, the time keeping system 100 includes three components: a time capture component 110, a time preparation component 120, and a time posting component 130.

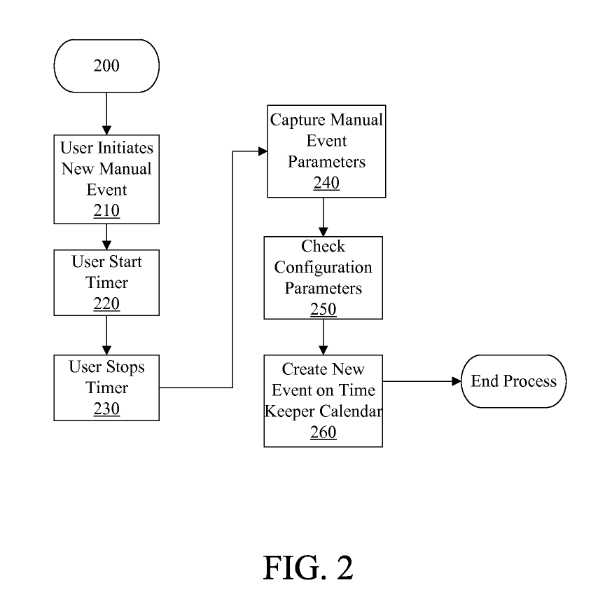

The time capture component 110 is configured to monitor and identify actions taken by a professional, collect event parameters related to those activities, and create an event with such event parameters within the time management application. The particular processes used in the time capture component 120 are dependent upon the type of activity being monitored. FIGS. 2-7 depict the various preferred processes used by the time capture component 130.

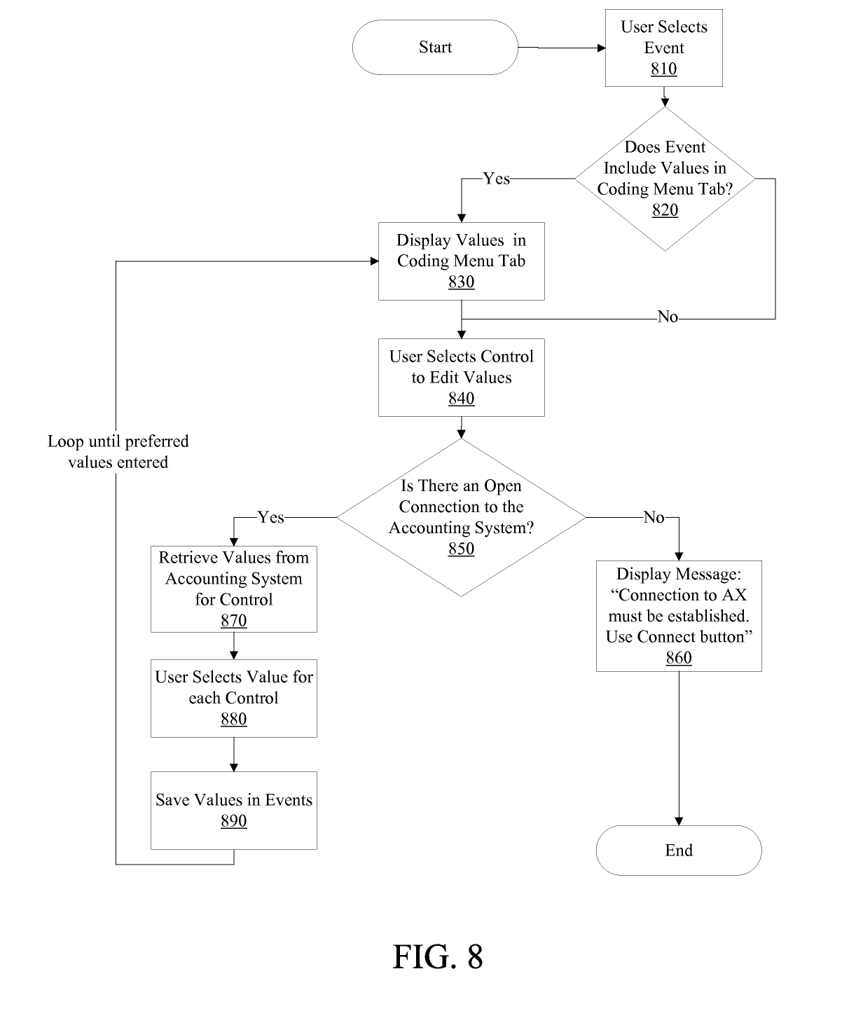

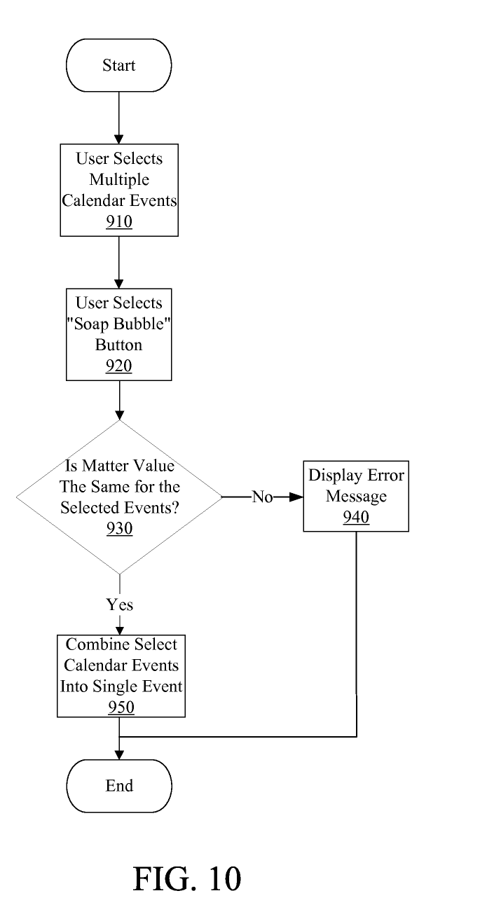

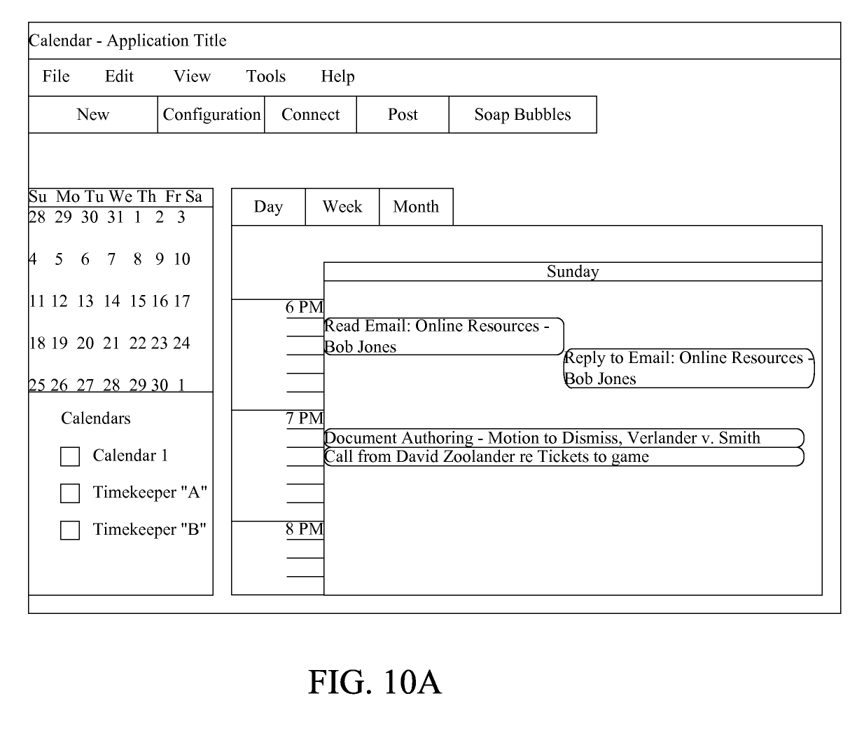

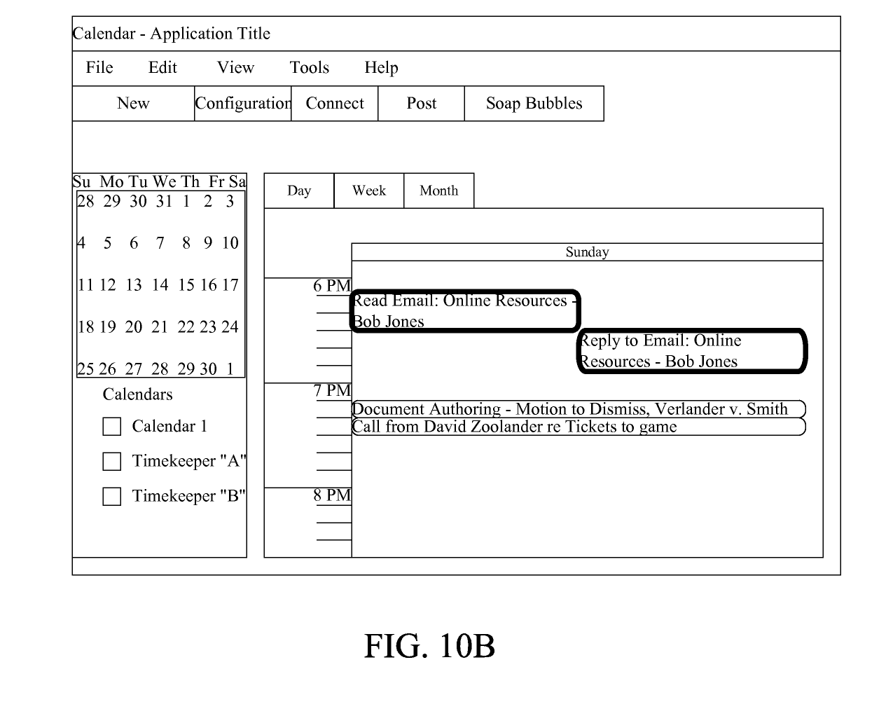

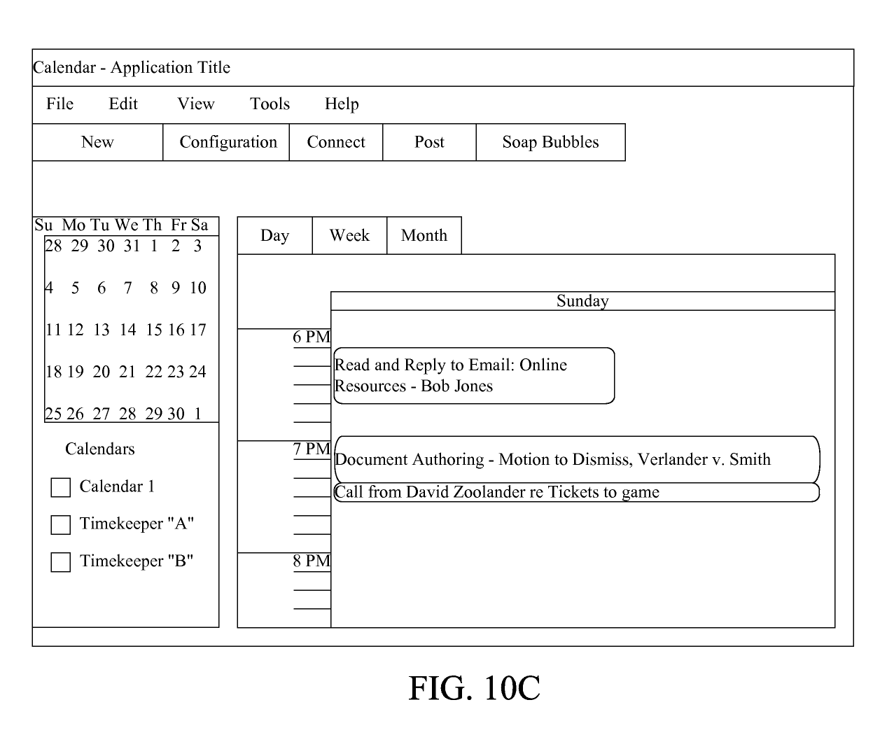

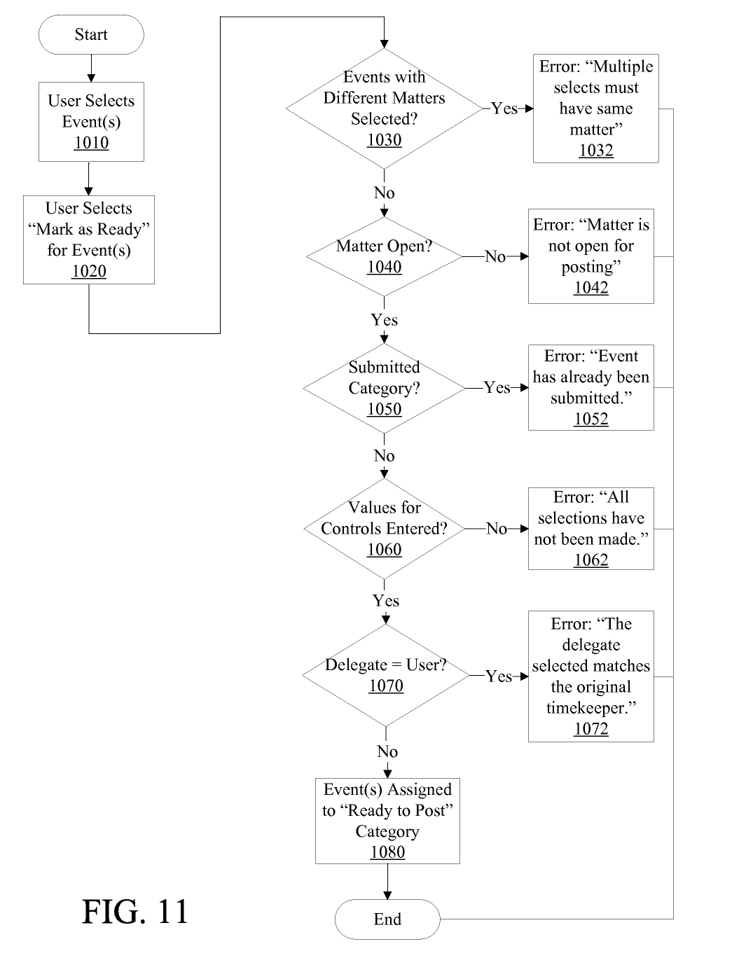

The time preparation component 120 includes processes that allow the events created in the time capture component 110 to be coded with selected values, selectively aggregated and marked as ready to be posted by the time posting component 130. These processes include a coding event process, depicted in FIG. 8, a soap bubble process, depicted in FIG. 10, and a mark as ready process, depicted in FIG. 11.

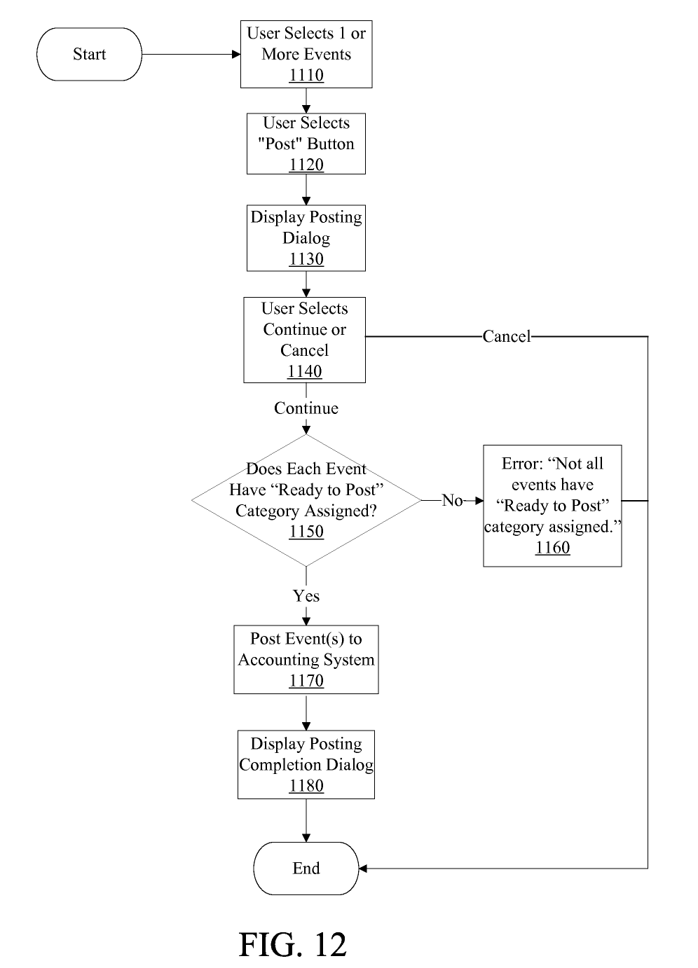

The time posting component 130 is configured to selectively post events created, coded, edited and aggregated in the other components of the time keeping system 100. The time posting component 130 includes a single post event process, which is depicted in FIG. 12.

Each of the three components of the time keeping system 100 use a time keeper calendar that is included in the time management application. FIGS. 10A-10C depict an embodiment of a time management application that includes a time keeper calendar. It will be understood that the time management application may be configured to use a single time keeper calendar, or multiple calendars, one of which is the time keeper calendar.

Turning back to FIGS. 2-7, the time capturing component 110 consists of several processes that enable a professional using the time keeping system 100 to capture various activities. These processes preferably include a process for capturing time spent reading, composing or replying to an email, a process for composing or editing various documents, and a process for making and/or receiving phone calls. Additionally, the processes within the time capturing component 110 may also consist of processes that capture activities manually entered by the professional.

As illustrated in FIG. 2, a flow chart diagram illustrates steps associated with a process for capturing a manual event within the time capturing component 110. Manual events might include various computer and/or non-computer related activities, such as meetings or reviewing paper documents. The manual process begins in step 210 where a manual event is initiated. In the preferred embodiment, the user initiates the manual event by selecting a button for new event from a toolbar within the time management application associated with the user.

It will be understood that in the preferred embodiment the new event button may be selected by clicking on a button labeled “New Event” within the time management application with a mouse or by using a keyboard or by other means, however, it will be understood that various interfaces and menus may be used whereby the user can initiate the new manual event. This is true for each of the user interface interactions used in the time keeping system 100, i.e., the particular user interface interaction may be accomplished in a variety of ways, so long as the particular goals and needs of each component of the time keeping system 100 are met.

It will also be understood that step 210 could alternatively be executed by selecting a specific start time from the time keeper calendar indicating when the user wants to start the new manual event. The time keeper calendar may be optionally configured so that once the user initiates the new manual event, the user may decide whether or not to input certain description information about the manual event.

The manual event process continues in step 220, where the user starts a timer which is associated with that event. It will be understood that step 220 may be set to be performed automatically when the user initiates the event in step 210. Once the user decides to complete the manual event, the user may stop the event by stopping the timer, as illustrated in step 230. Additionally, it will be understood that at any time after the timer is started, the user may pause the timer, without fully stopping the timer as indicated by step 230 and the user may restart the timer thereby continuing the time capture of that event.

In the preferred embodiment, after the manual event is complete and the timer has been stopped, the process moves to step 240, where the total elapsed time captured between steps 220 and 230 is determined. The total elapsed time may be shown on the time keeper calendar or displayed in an elapsed time box. The process next moves to step 250, which determines whether the total elapsed time captured meets certain event parameters, which may be previously set by a user. In the preferred embodiment, the event parameters are an incremental amount of time, such as a tenth of an hour or other time frame, however, it will be understood that other parameters may be utilized such as time of day, manual events captured per day, or the like. It should be further understood that step 250, while present in the preferred embodiment, is optional. In an alternative embodiment, a user may set the process to capture all manual events without any event parameters. After determining that the event parameters are set and fulfilled, or if there are no event parameters set, the process moves to step 260 and creates a new manual event on the time keeper calendar in the time management application.

In an alternative process of entering a manual event, the user may desire to enter a specific elapsed time for a certain event instead of starting and stopping the timer. Accordingly, the user may initiate the manual event in step 210, then enter the total elapsed time of that event into the time keeper calendar or the elapsed time box and then capture the event on the time keeper calendar by clicking a button allowing the user to save or to close the event.

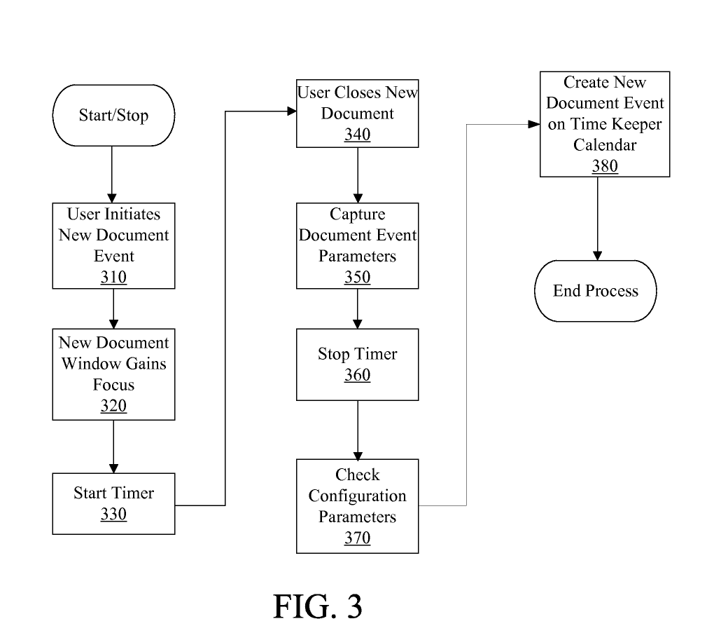

As illustrated in FIG. 3, a flow chart diagram illustrates steps associated with a process for capturing time spent composing or editing a document within the time capturing component 110. In a preferred embodiment, the document time capture event automatically captures time spent composing or editing a variety of documents in various software programs on a computer, such as Microsoft Office or Adobe Acrobat documents.

The automated document time capture process starts in step 310 when a user initiates a document event. Step 310 may be initiated by opening an existing document or by creating a new document. In the preferred embodiment, once a user has initiated a new document event, the process moves to step 320 to determine whether the document is the focus of the user's computer system, so that it is the primary view of the user's system. It will be appreciated that the user may be allowed to set certain parameters by which step 320 determines that the document is in focus. Additionally, it should be appreciated that step 320, while present in the preferred embodiment, is optional. In an alternative embodiment, step 320 is skipped in the automated document time capture process.

In the preferred embodiment, once step 320 determines the document is in focus, the process moves to step 330 and automatically starts a timer. It will be understood that if step 320 has been skipped, step 330 starts as soon as the user initiates the document in step 310. The process now moves to step 340 where the document is closed. It will be understood that the document may be closed by the user, automatically by the system, or by other system operations. Once the document is closed, the process moves to step 350 and captures various document parameters, such as the author, title and date of the document. Additionally, once the document has closed in step 340, the process stops the timer in step 360. The process then moves to step 370 and determines the total elapsed time of the new document event.

The process next moves to step 380, which determines whether the total time captured in the document time capture process meets certain event parameters, which may be previously set by a user. It will be understood that in the preferred embodiment, the event parameters are an incremental amount of time, such as a tenth of an hour or other time frame, however, it will be understood that other parameters may be utilized such as time of day, document events captured per day, or the like. It should be understood that step 380 is optional and a user may set the process to capture all automated document events without any event parameters. After determining that the event parameters are set and fulfilled, or if there are no event parameters set, the process moves to step 390 and creates a new document event on the time keeper calendar in the time management application.

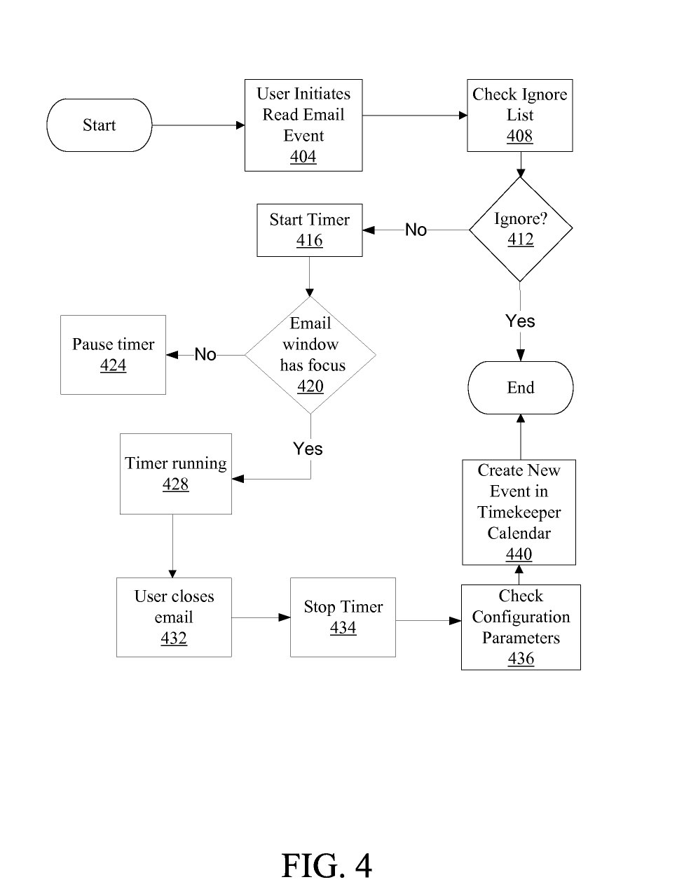

Now turning to FIG. 4, shown therein is a flow chart diagram illustrating steps associated with a process for capturing time spent reading an email within the time capturing component 110. In the preferred embodiment, the read email event time capture process automatically begins in step 404 when the user initiates a read email event. In the preferred embodiment, the user initiates the read email event by opening an existing email. In an alternative embodiment, the user initiates the read email event by selecting an email for display within the time management application. In such an alternative embodiment, the display of an email within the time management application executes step 404.

In the preferred embodiment, the process then moves to step 408 where the system checks to see whether the email address of the email is on an ignore list. It will be understood that the ignore list is optional, and if used, is configured by the user to include email addresses of particular contacts the user decides should never be considered by the process as a read email event. If the user has an ignore list, the process moves to step 412 to determine whether the email address associated with the read email event is located on the ignore list. If the email address is located on the ignore email list, then the process will stop and the read email activity will not be captured as a new read email event on the time keeper calendar. However, if the email address associated with the email is not located on the ignore email list, the process moves to step 416 and starts the timer. It will be understood that if the user does not have an ignore email list, the process automatically moves to step 416 and starts the timer.

As illustrated in decision step 420, if the read email is in focus so that it is the primary view on the user's system, the timer continues running as illustrated in step 428. It will be appreciated that the user may be allowed to set certain parameters by which step 420 determines that the read email event is in focus. Additionally, it should be appreciated that in alternative embodiments, step 420 may be skipped and not used in the automated read email time capture process. However, if the read email event is not in focus, the timer pauses the time capture process until the email is back in focus, whereupon the timer continues running. It will be understood that the read email event capture process may be configured so that the decision step 420 is disabled, so that the process will continue running without pause even if the read email event is not in focus.

Now moving to step 432, wherein the email is closed. It will be understood that step 432 may be performed by a user closing the new read email event, by the system closing the read email window, or by other known means. After the email is closed, the process next moves to step 434 and stops the timer. Thereafter, the process moves to step 436 which determines whether the total elapsed time captured meets certain event parameters, which may be previously set by a user. It will be understood that in the preferred embodiment, the event parameters are an incremental amount of time, such as a tenth of an hour or other time frame, however, it will be understood that other parameters may be included such as time of day, email events captured per day, or the like. It should be understood that step 436 is optional and a user may set the process to capture all new read email events without any configured event parameters. After determining that the event parameters are set, or if there are no event parameters set, the process moves to step 440 and creates a new read email event on the time keeper calendar in the time management application.

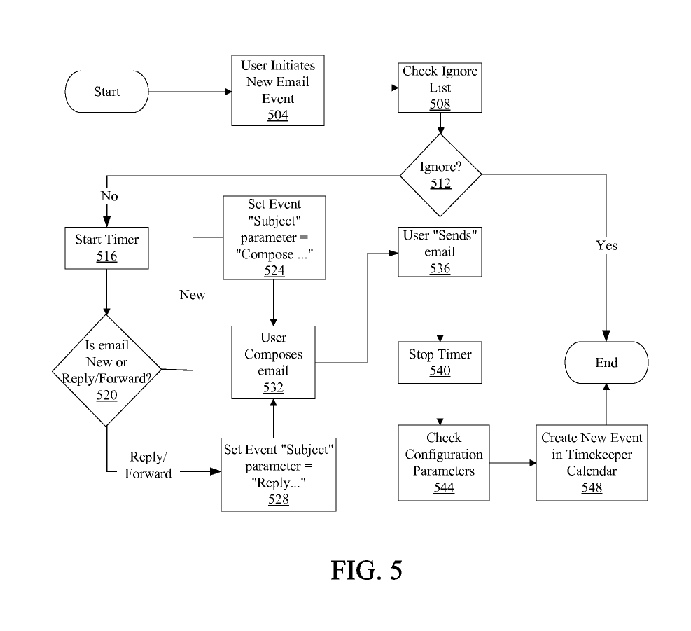

In FIG. 5 a flow chart diagram illustrates steps associated with a process for capturing time spent composing, replying or forwarding an email within the time capturing component 110. In the preferred embodiment, the new email event capture process automatically begins in step 504 when the user initiates a new email event. The user may initiate the new email event by composing a new email or by replying or forwarding an existing email. In the preferred embodiment, the user composes a new email by pressing a button in the toolbar in the user's email system labeled “New,” and the user replies or forwards a new email by pressing a button in the toolbar in the user's email system labeled “Reply” or “Forward.” However, it will be understood that other alternative embodiments are possible, depending upon the particular user interface employed by the email system.

In the preferred embodiment, after the new email event has been initiated, the process then moves to step 508 to check whether the email address entered by the user is on an ignore list. It will be understood that the ignore list is optional, and if used, is configured by the user to include email addresses of particular contacts the user decides should never be considered by the process as a new email event. If the user has an ignore list, the process moves to step 512 to determine whether the email address associated with the new email event is located on the ignore list. If the email address is located on the ignore email list, then the process will stop and the new email event will not be captured as a new email event on the time keeper calendar in the time management application. However, if the email address associated with the email is not located on the ignore email list, the process moves to step 516 and starts the timer. It will be understood that if the user does not have an ignore email list, the process automatically moves to step 516 and starts the timer.

As illustrated in decision step 520, the process next determines whether the new email event is a new compose email event or whether the new email event is a reply or forward email event. If the new email event is a new compose email event, the process moves to step 524 and sets event subject parameters for the new email event, such as “Compose email to Bob Jones . . . .” If the new email event is a reply email event or a forward email event, the process moves to step 528 and sets event subject parameters for the new email event, such as “Reply to Bob Jones . . . ” or “Forward to Bob Jones . . . .” The process then moves to step 532 wherein the user composes the new email event, which may include typing information into the body of the email, attaching documents, or other tasks. It will further be understood that similar to the process described in the new read email event time capture process, the new email event process may be configured to include a process that pauses the timer if the new email event is not in focus, so that it is the primary view on the user's system, and that when the new email event is in focus the timer will continue running. Also, it will be understood that if such a process is enabled on the new email event process, that the user may be allowed to set certain parameters for determining that the new email event is in focus.

Now the process moves to step 536 and the user sends the email. After the user sends the email in step 536 the process stops the timer in step 540. Thereafter, the process moves to step 544 which determines whether the total time captured meets certain event parameters, which may be previously set by a user. It will be understood that in the preferred embodiment, the event parameters are an incremental amount of time, such as a tenth of an hour or other time frame, however, it will be understood that other parameters may be utilized such as time of day, email events captured per day, or the like. It should be understood that step 544 is optional and a user may set the process to capture all new email events without any configured event parameters. After determining that the event parameters are set and fulfilled, or if there are no event parameters set, the process moves to step 548 and creates a new email event on the time keeper calendar in the time management application.

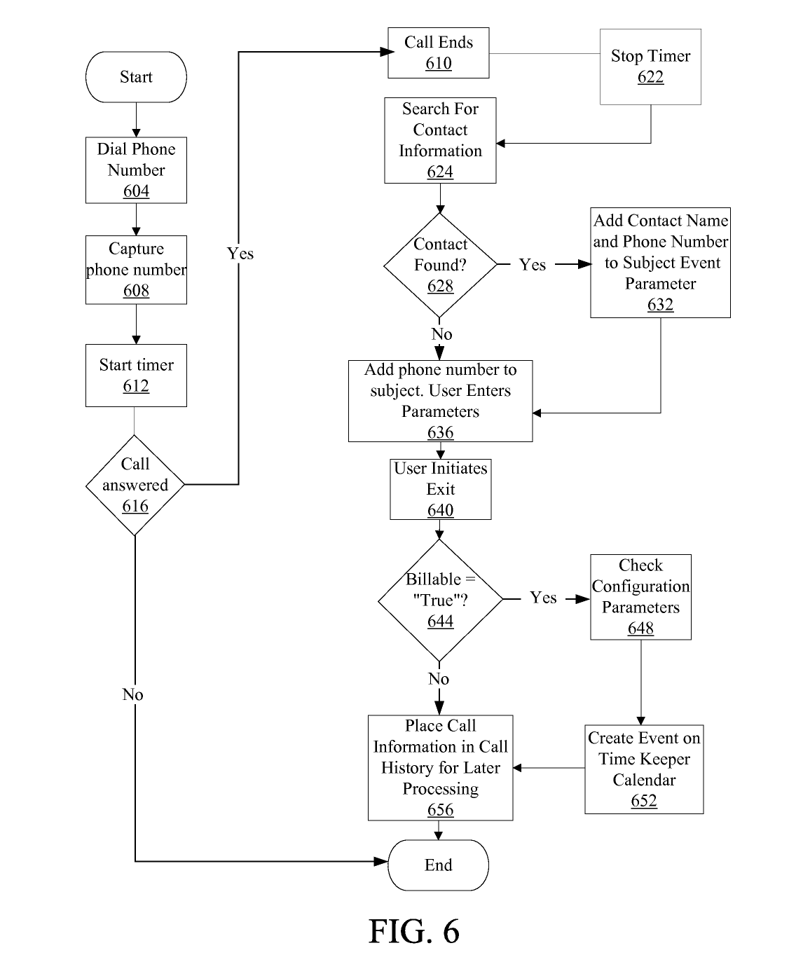

Now referring to FIG. 6, shown is a flow chart diagram illustrating steps associated with a process for capturing time spent making a phone call within the time capturing component 110. In the preferred embodiment, the process captures the phone calls using Voice Over IP (VoIP) on the Microsoft Lync, but it will be understood that other alternative embodiments are possible, depending upon the particular user interface or program employed by the user's computer system or mobile device.

In the preferred embodiment, the new make phone call event capture process begins in step 604 when the user initiates a new phone call event. The user initiates the new phone call event by dialing a phone number. The process then moves to step 608 where the process captures the phone number dialed by the user and then starts the timer in step 612. The process next moves to decision step 616 which determines whether or not the call initiated by the user is answered. If the call is not answered the process ends and the new make phone call event will not be captured as a new phone call event on the time keeper calendar in the time management application. If the call is answered, the process moves to step 620 where the call is ended. After the call is ended, processing moves to step 622 and the timer is stopped.

Processing then moves to step 624 wherein the system searches the user's contact list to determine whether the phone number dialed by the user matches information from the user's contact list. It will be understood that the user may or may not have a contact list with names and phone numbers of individuals in his email system or some other program or database on his computer system which may be searched by the time capturing component 110 of the time keeping system 100. It will also be understood that step 624 is optional and that the user may set parameters indicating that the user does not desire to search a contact list, and if so set, the process will move directly to step 636.

If the user has a contact list, then after the process searches the user's contact list, the process, in step 628, determines whether the phone number dialed by the user matches a number in the user's contact list. If the user has a contact list and the phone number dialed does not match a number in the user's contact list, the process moves to step 636 wherein the user inputs the phone number and name and other identifying information into the event subject parameters of the new make phone call event. If the user has a contact list and the phone number dialed by the user matches a phone number in the user's contact list then the process moves to step 632 and the contact name and phone number are added to the event subject parameters for the new received phone call event. The process then moves to step 636 to allow the user to input other identifying information into the event subject parameters of the new make phone call event.

After the event subject parameters are set, the process moves to step 640 and the user initiates exit by closing the VoIP session. The process then determines in step 644 whether the contact information entered into the event subject parameters is an event which may be billed to a certain account. If the event subject parameters indicate the make phone call event is not a billable event, the process moves to step 656 and places the make phone call event into a call history log for the user to review later at the user's convenience. If the make phone call event is determined to be a billable event, the process moves to step 648 and determines whether the total elapsed time captured by the make phone call event process meets certain configuration parameters, which may be previously set by a user. It will be understood that in the preferred embodiment, the configuration parameters are a minimal amount of time, such as a tenth of an hour or other time frame, however, it will be understood that other parameters may be utilized such as a particular time frame (e.g., after 9 a.m. and before 5 p.m.), a maximum or minimum number of make phone call events per day, or other similar configuration parameters that can be used to determine if the make phone call event process should be determined to be a billable event. It should be further understood that step 648 is optional and a user may set the process to capture all new make phone call events without any configured event parameters.

After determining that the event parameters are set and fulfilled, or if there are no event parameters set, the process moves to step 652 and creates a new make phone call event on the time keeper calendar in the time management application. Processing then also moves to step 656 and the make phone call event is saved to the call history log for the user to review later at the user's convenience.

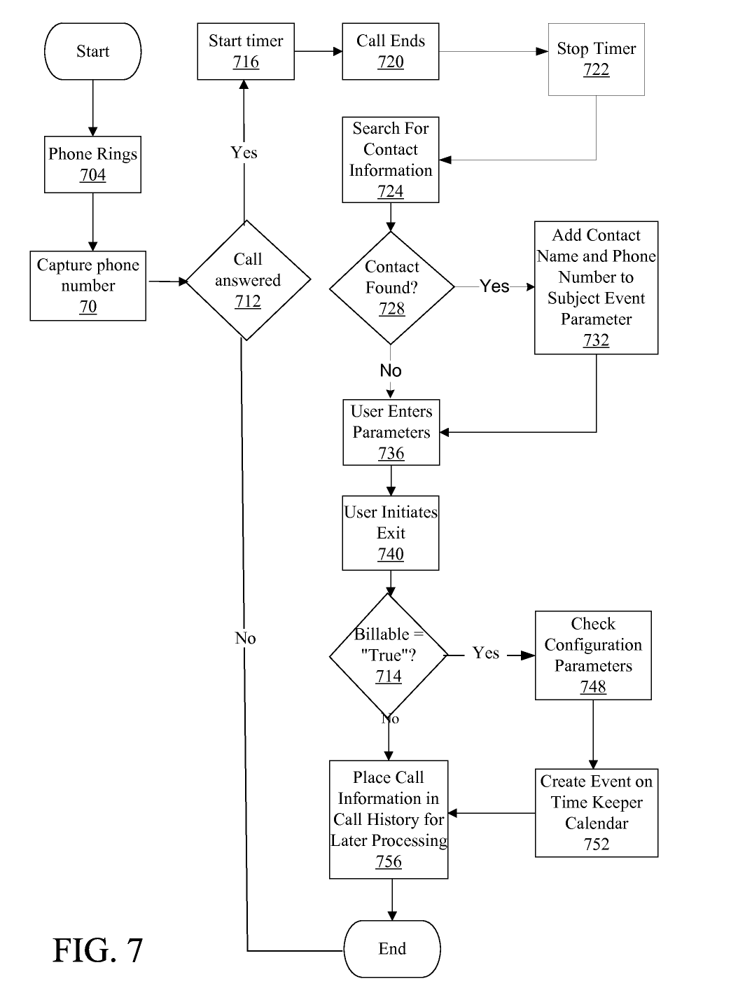

Now, referring to FIG. 7, shown therein is a is a flow chart diagram illustrating steps associated with a process for capturing time spent receiving a phone call within the time capturing component 110. In the preferred embodiment, the process captures the received phone call using Voice Over IP (VoIP), but it will be understood that other alternative embodiments are possible, depending upon the particular user interface or program employed by the user's computer system or mobile device.

In the preferred embodiment, the new received phone call event capture process begins in step 704 when the user's phone rings. The process then moves to step 708 wherein the phone number of the caller is captured by the system. Next, the process determines whether the user answers the phone call in step 712. If the user does not answer the phone call, the process ends and the new received phone call event will not be captured as a new phone call event on the time keeper calendar in the time management application. If the call is answered, the process moves to step 716 where the timer is started. Processing then moves to step 720 where the call is ended. After the call is ended, processing moves to step 722 and the timer is stopped.

Processing then moves to step 724 wherein the system searches the user's contact list to determine whether the phone number used to call the user matches information from the user's contact list. It will be understood that the user may or may not have a contact list with names and phone numbers of individuals in his email system or some other program or database on his computer system which may be searched by the time capturing component 110 of the time keeping system 100. It will also be understood that step 724 is optional and that the user may set parameters indicating that the user does not desire to search a contact list, and if so set, the process will move directly to step 736.

If the user has a contact list, then after the process searches the user's contact list, the process, in step 728, determines whether the caller's phone number matches a number in the user's contact list. If the user has a contact list and the caller's phone number does not match a number in the user's contact list, the process moves to step 736 wherein the user inputs the caller's phone number and name and other identifying information into the event subject parameters of the new make phone call event. If the user has a contact list and the caller's phone number matches a phone number in the user's contact list then the process moves to step 732 and the contact name and phone number are added to the event subject parameters for the new received phone call event. The process then moves to step 736 to allow the user to input other identifying information into the event subject parameters of the new make phone call event.

After the event subject parameters are set, the process moves to step 740 and the user initiates exit closing the VoIP session. The process then determines in step 744 whether the contact information entered into the event subject parameters is an event which may be billed to a certain account. If the event subject parameters indicate the make phone call event is not a billable event, the process moves to step 756 and places the received phone call event into a call history log for the user to review later at the user's convenience. If the received phone call event is determined to be a billable event, the process moves to step 748.

In step 748, the process determines whether the total elapsed time captured by the received phone call event process meets certain configuration parameters, which may be previously set by a user. It will be understood that in the preferred embodiment, the configuration parameters are a minimal amount of time, such as a tenth of an hour or other time frame, however, it will be understood that other parameters may be utilized such as a particular time frame (e.g., after 9 a.m. and before 5 p.m.), a maximum or minimum number of make phone call events per day, or other similar configuration parameters that can be used to determine if the received phone call event process should be determined to be a billable event.

After determining that the event parameters are set and fulfilled, or if there are no event parameters set, the process moves to step 752 and creates a new received phone call event on the time keeper calendar in the time management application. Processing then also moves to step 756 and the make phone call event is saved to the call history log for the user to review later at the user's convenience.

Now turning to FIGS. 8-11, shown therein are various processes included in the time preparation component 120 of the time keeping system 100.

The time preparation component includes a coding process, as depicted in FIG. 8. This process begins in step 810 wherein the user selects an event from the time keeper calendar that the user wants to code. The user will then initiate the coding process. In the preferred embodiment, initiation is accomplished by clicking on a coding menu tab in the time keeper calendar. An illustration of the coding menu tab used in coding process is illustrated in FIG. 9. The coding menu tab includes a plurality of controls that display and allow selection of values associated with the selected event.

In the preferred embodiment, the time preparation component 120 includes a soap bubble process, as depicted in FIG. 10. The soap bubble process of the time preparation component 120 is configured to permit a professional using the time keeping system 100 to aggregate separate events created by the time capture component 110 into single events. This is helpful to professionals that desire to “block bill” certain activities, i.e., generate an invoice that groups several billable activities in a single line item on that invoice, as opposed to creating a line item for each activity on the invoice. This process begins in step 910 wherein the user selects multiple events from the time keeper calendar that the user wants to aggregate (or combine) into a single event. In the preferred embodiment, the user accomplishes this by pressing and holding the “CTRL” key and then clicking on more than one event on the time keeper calendar. FIGS. 10A, & 10B depict an example of step 910. FIG. 10A depicts a typical time management application with a calendar planner object that displays four events previously created by the time capture component 110, prior to execution of 910. FIG. 10B depicts the same four events after the execution of Step 910, wherein the user selected the two events labeled “Read Email: Online Resources—Bob Jones” and “Reply to Email: Online Resources—Bob Jones.” A comparison of FIG. 10A with FIG. 10B shows that the two selected events have been highlighted by the execution of step 910.

Processing then moves to step 920, wherein the user indicates that all of the events to be combined into a single event have been selected. In the preferred embodiment, the user executes step 920 by pressing a button on a toolbar in the time management application. It will be understood that the step 920 could alternatively be executed by choosing a menu item from a context sensitive menu (or a “right click” or “drop down” menu) or by choosing a menu from one of the menus in the menu bar of the time management application. In the preferred embodiment, the label of the button in the toolbar or menu is “Soap Bubble.”

Upon completion of step 920, processing moves to step 930. In step 930, the soap bubble process determines whether the selected events in step 910 have the same matter value. If the selected events do not have the same matter value, the processing turns to step 940 where an error message is displayed to the user indicating the matter values are not the same and the soap bubble process ends. If the selected events have the same matter value, processing moves to step 950.

In step 950, the events selected in step 910 are deleted from the calendar planner object of the time management application, and replaced with a single event with event parameters and values chosen, calculated and combined from the selected events. The start time event parameter of the single event is set to the earliest start time parameter of all the deleted events. The elapsed time parameter of the single event is set to the sum of the elapsed time parameters of the deleted events. The subject parameter of the single event is set to the concatenation of the subject parameters of the deleted events. Likewise the notes parameter of the single event is set to the concatenation of the notes parameters of the deleted events.

In a preferred embodiment, the time preparation component 120 also includes an a mark as ready process, as depicted in FIG. 11. This process begins in step 1010 wherein the user selects one or more events from the time keeper calendar that the user wants to mark as ready for processing by the posting process of the time posting component 130. In the preferred embodiment, this is accomplished by pressing and holding the “CTRL” key and then clicking on more than one event on the time keeper calendar. In this way, the preferred embodiment of step 1010 is similar to the preferred embodiment of step 910. It will be understood, however, that step 910 and step 1010 do not necessarily need to be accomplished in the same manner.

In the preferred embodiment, the user then executes step 1020 by selecting “Mark as Ready” for the event(s). The user accomplishes this by choosing a menu item from a context sensitive menu (or a “right click menu”) or by choosing a toolbar button menu from one of the menus in the menu bar of the time management application. In the preferred embodiment, the label of the button in the toolbar, or the menu item, is labeled “Mark as Ready.” The mark as ready process then validates that the events selected in step 1010 are properly configured to be processed by the posting process of the time posting component 130. This validation is performed in steps 1030 through 1070.

In step 1030 the mark as ready process determines whether the events selected in step 1010 have the same matter value. If the selected events do not have the same matter value, the processing turns to step 1032 where an error message is displayed to the user indicating the matter values are not the same and the mark as ready process ends. If the selected events have the same matter value, the process moves to another validation step.

In step 1040, the mark as ready process determines whether the events selected in step 1010 have a matter value entered for which the accounting system will permit time and other information to be posted. If the accounting system does not allow posting for the matter value entered, the process turns to step 1042 where an error message is displayed to the user indicating the matter is not open for posting. If the accounting system does allow posting, the process moves to another validation step.

In step 1050, the mark as ready process determines whether the events selected in step 1010 have already been submitted to the accounting system. If the events have already been submitted, processing moves to step 1052 where an error message is displayed to the user indicating the event selected has already been submitted and the mark as ready process ends. If the selected events have not been previously submitted, the process moves to another validation step.

In step 1060, the mark as ready process determines whether the events selected in step 1010 have all of the preferred values for the controls in the coding menu tab of the coding process entered. If the preferred values are not entered, the mark as ready process moves to step 1062 and displays an error message to the user indicating that all preferred values have not been entered and the process ends. If the preferred values have been entered, the process moves to another validation step.

In step 1070, the mark as ready process determines whether the events selected in step 1010 have a delegate value entered in the coding process that is the same as the user. If the delegate value is the same as the user, the process moves to step 1072 and displays an error to the user that the delegate is the same as the original timekeeper and the process ends. If the delegate value is not the same as the user, the process moves to another validation step.

After the validation steps 1030 through 1070 have been performed, and no errors are returned, the mark as ready process moves to step 1080. In step 1080, the selected events of step 1010 are assigned a ready to post category.

Turning to FIG. 12, shown therein is the posting process of the time posting component 130. The time posting component 130 enables the user, or the user's delegate, to send events created, coded, aggregated and marked as ready in the other components to the accounting system for later inclusion in timesheets, reports, pre-bills and invoices.

The posting process begins in step 1110 by the user, or user's delegate, selecting multiple events from the calendar that the user wants to post to a timesheet. In the preferred embodiment, this is accomplished by pressing and holding the “CTRL” key and then clicking on more than one event on the time keeper calendar. In this way, the preferred embodiment of step 1110 is similar to the preferred embodiment of steps 910 and 1010. It will be understood, however, that step 910, step 1010 and step 1110 do not necessarily need to be accomplished in the same manner.

After step 1010 is executed, processing moves to step 1020, wherein the user wherein the user indicates that all of the events to be posted have been selected. In the preferred embodiment, this is accomplished by pressing a button in the toolbar in the time management application labeled “Post,” or by choosing a menu item from a context sensitive menu (or a “right click” or “drop down” menu). It will be understood that other alternative embodiments are possible, depending upon the particular user interface employed by the time management application.

Once the user indicates the events to be posted, processing moves to step 1130 and displays a posting dialog message to the user indicating that the events will be posted and asking the user whether the user would like to cancel posting or continue with posting. The process then moves to step 1104 wherein the user selects to continue or cancel the posting from a selection option within the posting dialog message. It will be understood that other alternative methods of cancelling the posting process are possible, such as by the user selecting to “X” out of the posting dialog message or by closing the time keeper calendar altogether. If the user selects to cancel the posting process, then the posting process ends. If the user selects to continue the posting process, the processing moves to step 1140.

In step 1150, the posting process determines whether each event selected in step 1110 has been assigned a ready to post category from step 1080 of the mark as ready process. If each event has not been assigned a ready to post category, then the process turns to step 1160 and displays an error to the user indicating that all selected events are not ready to post. If all events have been assigned a ready to post category, then processing turns to step 1170 and the events are posted to the accounting system. In a preferred embodiment, after the events are posted processing moves to step 1180 and a posting completion dialog is displayed to the user indicating the number of events posted, the matter value the events were posted to in the accounting system and the number of hours for the events posted.

Although the present invention has been described with reference to particular embodiments, persons skilled in the art will recognize that changes may be made in form and detail without departing from the spirit and scope of the invention.

What is claimed is:

1. A computer system configured to capture parameters related to billable events and report those parameters to an accounting program, the system comprising:
a calendar component configured to display and store the parameters for the billable events;
at least one capture component configured to determine the parameters of a billable event and further configured to provide those parameters to the calendar component for storage and display; and
a posting component configured to retrieve the parameters of selected billable events from the calendar component and report those parameters to the accounting program;
wherein the calendar component can combine the parameters of each of the billable events in a selected plurality of billable events and create a new billable event.
